(19) United States
(12) Patent Application Publication
(10) Pub. No.: US 2025/0299852 A1
(43) Pub. Date: Sep. 25, 2025

(54) Method of Manufacturing a Wet or Semi-Wet Design High Voltage Submarine Power Cable

(71) Applicant: NKT HV Cables AB, Lyckeby (SE)

(72) Inventors: Peter Friberg, Rödeby (SE); Kristian Gustafsson, Karlskrona (SE); Tommy Johansson, Bräkne-Hoby (SE); Peter Sunnegårdh, Kallinge (SE); Johan Fagrell, Malmö (SE); Erik Eriksson, Cary, NC (US)

(21) Appl. No.: 19/071,871

(22) Filed: Mar. 6, 2025

(30) Foreign Application Priority Data
Mar. 21, 2024 (EP) 24165310.4

(51) Int. Cl. H01B 13/14; H01B 7/14; H01B 7/282; H01B 7/285; H01B 13/02

(52) U.S. Cl. CPC H01B 13/147; H01B 7/14; H01B 7/2825; H01B 7/285; H01B 13/0207

(57) ABSTRACT

A method of manufacturing a wet or semi-wet design high voltage or extra high voltage submarine power cable, the method including: a) supplying polymer materials to an extruder from a material handling room, the material handling room fulfilling clean room class 8 or cleaner according to ISO-14644-1: 2015, and b) extruding an insulation system, including an insulation layer, around a conductor in the extruder using the polymer material, the extruder fulfilling the requirements of clean room class 8 or cleaner according to ISO-14644-1: 2015.

### TECHNICAL FIELD

The present disclosure generally relates to wet or semi-wet submarine power cables.

### BACKGROUND

Submarine power cables have traditionally been designed with a dry design. This means that a submarine power cable has a radial metallic water barrier outside the insulation system, which hermetically seals the insulation system.

A radial metallic water barrier that hermetically seals the insulation system is formed by extrusion or by longitudinal welding of a metallic sheath. The water barrier has traditionally been made of lead, but nowadays many different leadfree metals have been proposed, such as various copper alloys, aluminium, or stainless steel.

In case water is able to come in contact with the insulation system, the relative humidity in the insulation system increases. If the relative humidity exceeds a threshold value, the insulation system may be subjected to water-treeing, which can cause partial discharge activities or breakdown of the insulation system.

It has been realised by the present inventors that water treeing occurs due to the presence of impurities in the insulation layer in combination with the electric field across the insulation layer. The higher the electric field in the presence of a humid insulation layer, the higher the risk of water treeing in case the insulation system contains impurities. Thus, if the insulation layer can be produced without or with only a very small quantity of foreign particles, water treeing could potentially be avoided in submarine cable designs that are not dry, i.e., which have a wet or semi-wet design, even for high voltage or extra high voltage applications. This would potentially save size, weight, and material.

While ultraclean polymeric insulation materials are available on the market such as Borlink™ compounds from Borealis, the mere use of such material will not necessarily result in an insulation layer that is sufficiently free of foreign particles of a type that can cause water treeing, especially in higher voltage applications such as above 72 kV or even above 100 kV.

### SUMMARY

In view of the above, an object of the present disclosure is to provide a method which solves or at least mitigates the problems of the prior art.

There is hence according to a first aspect of the present disclosure provided a method of manufacturing a wet or semi-wet design high voltage or extra high voltage submarine power cable, the method comprising: a) supplying polymer materials to an extruder from a material handling room, the material handling room fulfilling clean room class 8 or cleaner according to ISO-14644-1: 2015, and b) extruding an insulation system, including an insulation layer, around a conductor in the extruder using the polymer materials, the extruder fulfilling the requirements of clean room class 8 or cleaner according to ISO-14644-1: 2015.

The high voltage (HV) or extra high voltage (EHV) submarine power cable manufactured according to the method has an insulation system, in particular an insulation layer, that is able to withstand a wet environment even at high and extra high voltage levels. This makes it unnecessary to use a metallic water barrier for protection of the insulation system against radial water ingression.

The HV or EHV submarine power cable may be a dynamic submarine power cable or alternatively a static submarine power cable.

The HV or EHV submarine power cable may be an AC submarine power cable or a DC submarine power cable. Water-treeing is in theory mainly an issue in AC applications, where the electric field over the insulation layer varies, but since the voltage in DC applications may include harmonics with various frequencies and amplitudes, water-treeing may also be an issue in DC applications.

The HV or EHV submarine power cable may be free of water-swellable tape. Water-swellable tape may comprise contaminants that can migrate into the insulation system. This could potentially make the insulation layer susceptible to water-treeing as a result of contamination from the water-swellable tape after the HV or EHV submarine power cable has been manufactured.

A wet HV or EHV submarine power cable is free of a metallic radial water barrier that hermetically seals the insulation system. Hereto, a wet HV or EHV submarine power cable does not comprise a metallic water blocking barrier that is longitudinally welded, soldered, extruded, longitudinally glued, or a wound water-blocking metallic tape. A semi-wet HV or EHV submarine power cable has a metallic radial water barrier that does not hermetically seal the insulation system. The metallic water barrier may for example be formed by longitudinally gluing a metallic tape folded around the insulation system or by winding a water-blocking metallic tape around the insulation system.

According to one embodiment step a) involves supplying the polymer materials from containers arranged in the material handling room, via a tapping opening of each container, to the extruder.

According to one embodiment step a) involves supplying the polymer materials from the tapping openings into a glovebox, wherein the glovebox fulfils clean room class 6 or cleaner according to ISO-14644-1: 2015.

The handling of the polymer material before it enters the extruder is thus also very clean, ensuring that contamination of the polymer materials from contact with ambient air can be kept minimal.

One embodiment comprises connecting, inside the glovebox, the tapping openings to a material supplying system connected to the extruder.

According to one embodiment the glovebox contains filtered air with an overpressure relative to the pressure in the material handling room. The risk of entry of foreign particles from the material handling room into the glovebox may thus be reduced.

One embodiment comprises, prior to step a) forming the conductor by stranding a plurality of wires, wherein the stranding involves applying a water blocking compound around the wires to remove voids between the wires inside the conductor. Longitudinal water ingression in the conductor may thus be reduced, which may be particularly relevant for wet and semi-wet power cables which by design allow radial water ingression into a conductor with voids and which may instantly vaporise in the event of a short circuit current.

According to one embodiment the submarine power cable is rated for at least 72 kV.

According to one embodiment the submarine power cable is rated for at least 132 kV.

According to one embodiment a wet design submarine power cable is free of an extruded or longitudinally welded or soldered metallic water barrier and free of a glued metallic water barrier.

According to one embodiment a semi-wet design submarine power cable is free of an extruded or longitudinally welded or soldered metallic water barrier and comprises a glued metallic water barrier surrounding the insulation system.

There is according to a second aspect of the present disclosure provided a high voltage or extra high voltage wet or semi-wet design submarine power cable obtainable by means of the method of the first aspect.

Generally, all terms used in the claims are to be interpreted according to their ordinary meaning in the technical field, unless explicitly defined otherwise herein. All references to “a/an/the element, apparatus, component, means”, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 schematically shows a cross section of an example of a wet or semi-wet HV or EHV submarine power cable;

FIG. 2 is a flowchart of a method of manufacturing a wet or semi-wet HV or EHV cable, such as the submarine power cable in FIG. 1; and

FIG. 3 schematically shows a clean room system for polymer materials.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

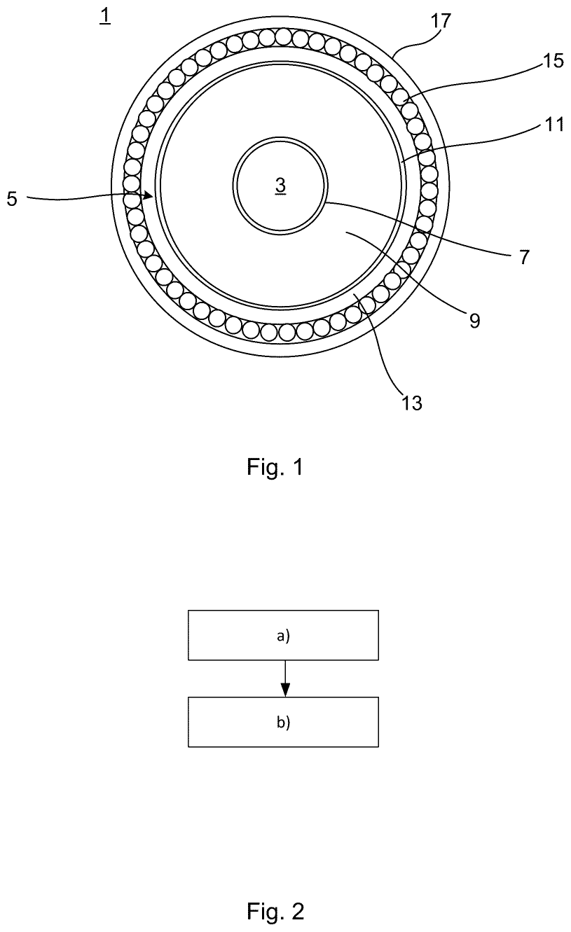

FIG. 1 shows an example of a wet or semi-wet HV or EHV submarine power cable 1.

The submarine power cable 1 comprises a conductor 3. The conductor 3 may for example be stranded round conductor, a stranded compacted conductor, of Milliken type, or solid. The conductor may for example comprise copper or aluminium.

The submarine power cable 1 comprises an insulation system 5. The insulation system surrounds the conductor 3. The insulation system 5 comprises an inner semiconducting layer 7 arranged around the conductor 3, an insulation layer 9 arranged around the inner semiconducting layer 7, and an outer semiconducting layer 11 arranged around the insulation layer 9.

The insulation system 5 is an extruded insulation system comprising polymer material. Each of the inner semiconducting layer 7 and the outer semiconducting layer 11 comprises a base polymer mixed with a conductive component such as carbon black. The inner semiconducting layer 7 and the outer semiconducting layer 11 may be the same material or they may be different materials. In one example, the inner semiconducting layer 7 may comprise acetylene black as conductive component. In one example, the outer semiconducting layer 11 may comprise a carbon black other than acetylene black as conductive component. A semiconducting layer comprising acetylene black has lower water absorption capability than other types of carbon black.

The polymer material used as base for the inner semiconducting layer 7 and the outer semiconducting layer 11 may for example be polyethylene, crosslinked polyethylene, polypropylene, ethylene propylene diene monomer (EPDM) rubber, or ethylene propylene rubber (EPR).

The insulation layer 9 may for example comprise polyethylene such as crosslinked polyethylene (XLPE), polypropylene, EPDM rubber, or EPR.

The submarine power cable 1 may comprise a polymer layer 13 arranged around the outer semiconducting layer 11. The polymer layer 13 may be bonded to the outer surface of the outer semiconducting layer 11 by means of an adhesive such as a hot melt adhesive. According to one example, the polymer layer 13 may be applied directly onto the outer semiconducting layer 13 without an adhesive in between. The polymer layer 13 may be extruded onto the outer semiconducting layer 11. According to one example, the polymer layer 13 may be the outermost layer of the submarine power cable 1.

In one example, the submarine power cable 1 may comprise a screen layer (not shown) formed by helically laid metal wires such as copper wires. The screen layer may in this case be arranged between the outer semiconducting layer 11 and the polymer layer 13.

The submarine power cable 1 may comprise one or more armour layer 15. The armour layer(s) 15 is arranged around the polymer layer 13. Each armour layer 15 may comprise a plurality of helically laid armour wires. The armour wires may for example be made of metal, a synthetic material such as a polymer-based material, or some may be made of metal and others may be made of synthetic material.

The submarine power cable 1 may comprise an outer sheath or outer serving 17. The outer sheath or outer serving 17 is arranged around the armour layer(s) 15. The outer sheath or outer serving 17 is according to some examples the outermost layer of the submarine power cable 1.

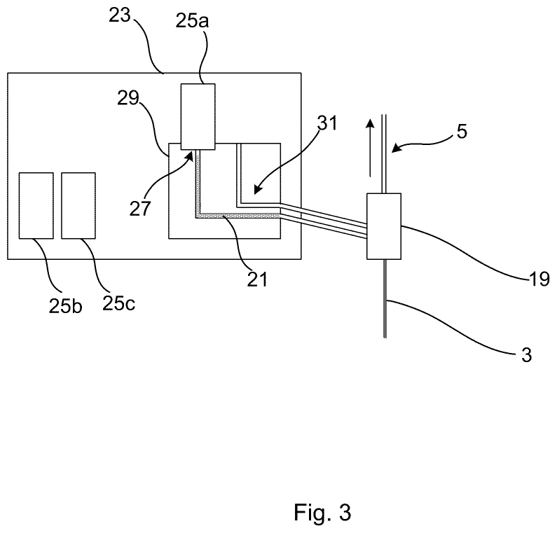

A method of producing a wet or semi-wet HV or EHV submarine power cable, such as the submarine power cable 1 will now be described with reference to FIGS. 2-3. It is to be noted that while the example in FIG. 1 discloses a single core submarine power cable, the method may be used to manufacture an HV or EHV submarine power cable with a plurality of power cores, each having a wet or semi-wet design, thus also making the submarine power cable with several power cores a submarine power cable with wet or semi-wet design.

In a step a) polymer materials, such as polymer material 21, are supplied to an extruder 19 from a material handling room 23. The polymer materials supplied from the material handling room 23 include a semiconducting polymer material and an electrically insulating polymer material.

The polymer materials supplied to the extruder 19 are typically in the form of pellet or granules.

The material handling room 23 fulfils clean room class 8 or cleaner according to ISO-14644-1: 2015.

According to one example, step a) involves supplying the polymer materials from containers 25a-25c arranged in the material handling room. One or more containers 25a-25c contain polymer material in the form of semiconducting polymer material. One or more containers 25a-25c contain polymer material in the form of electrically insulating polymer material.

Each container 25a-25c has a tapping opening 27. The supplying in step a) may involve supplying the polymer materials from the containers 25a-25c to the extruder through the tapping openings 27.

In one example, step a) involves supplying the polymer materials from the tapping openings 27 into a glovebox 29. The glovebox 29 may be arranged in the material handling room 23. The glovebox 29 fulfils clean room class 6 or cleaner according to ISO-14644-1: 2015.

In one example the tapping openings 27 of the containers 25a-25c are connected, inside the glovebox 29, to a material supplying system 31 connected to the extruder 19. The tapping openings 27 may be connected such that several containers 25a-25c containing different types of polymer materials are connected to the material supplying system 31 at the same time, or a tapping opening 17 may be connected, wherein the container 25a is emptied and then disconnected before the next container 25b, 25c is connected, emptied, and then disconnected.

The glovebox 29 may contain filtered air with an overpressure relative to the pressure in the material handling room 23.

In a step b) the insulation system 5 is extruded around the conductor 3 using the polymer materials supplied from the material handling room 23. The extruder 19 fulfils the requirements of clean room class 8 or cleaner according to ISO-14644-1: 2015.

The extruder 19 may be arranged to extrude the inner semiconducting layer 7, the insulation layer 9, and the outer semiconducting layer 11 simultaneously, forming the insulation system 5 by triple extrusion.

In one example the conductor 3 is formed by stranding a plurality of wires before step a). The stranding involves applying a water blocking compound around the wires to remove voids between the wires inside the conductor 3.

After step b), additional layers may be formed around the outer semiconducting layer 11, in different locations of the assembly line, e.g., the screen layer, the polymer layer 13, one or more armour layer 15, and/or the outer sheath/outer serving 17.

If the submarine power cable that is being manufactured has a wet design, then no metallic water barrier is applied around the insulation system 5. Thus, the submarine power cable is free of a metallic water barrier.

If the submarine power cable that is being manufactured has a semi-wet design, then a metallic tape may be folded around the insulation system 5 with opposing edges bonded in the longitudinal direction to form a non-hermetically sealed metallic water barrier. Alternatively, a metallic tape may be wound around the insulation system 5 to form a non-hermetically sealed wound metallic water barrier.

The wet or semi-wet submarine power cable thus manufactured may be rated for at least 72 kV, such as for at 132 kV.

The inventive concept has mainly been described above with reference to a few examples. However, as is readily appreciated by a person skilled in the art, other embodiments than the ones disclosed above are equally possible within the scope of the inventive concept, as defined by the appended claims.

1. A method of manufacturing a wet or semi-wet design high voltage or extra high voltage submarine power cable, the method comprising:
a) supplying polymer materials to an extruder from a material handling room, the material handling room fulfilling clean room class 8 or cleaner according to ISO-14644-1: 2015, and
b) extruding an insulation system, including an insulation layer, around a conductor in the extruder using the polymer materials, the extruder fulfilling the requirements of clean room class 8 or cleaner according to ISO-14644-1: 2015.

2. The method as claimed in claim 1, wherein step a) involves supplying the polymer materials from containers arranged in the material handling room, via a tapping opening of each container, to the extruder.

3. The method as claimed in claim 2, wherein step a) involves supplying the polymer materials from the tapping openings into a glovebox, wherein the glovebox fulfils clean room class 6 or cleaner according to ISO-14644-1: 2015.

4. The method as claimed in claim 3, comprising connecting, inside the glovebox, the tapping openings to a material supplying system connected to the extruder.

5. The method as claimed in claim 4, wherein the glovebox contains filtered air with an overpressure relative to the pressure in the material handling room.

6. The method as claimed in claim 1, comprising, prior to step a) forming the conductor by stranding a plurality of wires, wherein the stranding involves applying a water blocking compound around the wires to remove voids between the wires inside the conductor.

7. The method as claimed in claim 1, wherein the submarine power cable is rated for at least 72 kV.

8. The method as claimed in claim 1, wherein the submarine power cable is rated for at least 132 kV.

9. The method as claimed in claim 1, wherein a wet design submarine power cable is free of an extruded or longitudinally welded or soldered metallic water barrier and free of a glued metallic water barrier.

10. The method as claimed in claim 1, wherein a semi-wet design submarine power cable is free of an extruded or longitudinally welded or soldered metallic water barrier and comprises a glued metallic water barrier surrounding the insulation system.

11. A high voltage or extra high voltage wet or semi-wet design submarine power cable made by
a) supplying polymer materials to an extruder from a material handling room, the material handling room fulfilling clean room class 8 or cleaner according to ISO-14644-1: 2015, and
b) extruding an insulation system, including an insulation layer, around a conductor in the extruder using the polymer materials, the extruder fulfilling the requirements of clean room class 8 or cleaner according to ISO-14644-1: 2015.

12. The method as claimed in claim 2, comprising, prior to step a) forming the conductor by stranding a plurality of wires, wherein the stranding involves applying a water blocking compound around the wires to remove voids between the wires inside the conductor.

13. The method as claimed in claim 2, wherein the submarine power cable is rated for at least 72 kV.

14. The method as claimed in claim 2, wherein the submarine power cable is rated for at least 132 kV.

15. The method as claimed in claim 2, wherein a wet design submarine power cable is free of an extruded or longitudinally welded or soldered metallic water barrier and free of a glued metallic water barrier.

16. The method as claimed in claim 2, wherein a semi-wet design submarine power cable is free of an extruded or longitudinally welded or soldered metallic water barrier and comprises a glued metallic water barrier surrounding the insulation system.
